(19) United States
(12) Patent Application Publication
(10) Pub. No.: US 2008/0315014 A1
(43) Pub. Date: Dec. 25, 2008

(54) Personal Cooling Device for a Motorcycle Rider

(76) Inventor: Allen D. Spurlin, Clear Spring, MD (US)

Correspondence Address: WHITE-WELKER & WELKER, LLC, P.O. BOX 199, CLEAR SPRING, MD, 21722-0199, US

(21) Appl. No.: 12/143,775

(22) Filed: Jun. 21, 2008

Related U.S. Application Data
(60) Provisional application No. 60/945,360, filed on Jun. 21, 2007.

(51) Int. Cl. B05B 15/00

(52) U.S. Cl. 239/289

(57) ABSTRACT

The present invention is a personal cooling device for use during the operation of a motorcycle to provide a mist of water to keep a rider or passenger cool during hot weather. The device in a first embodiment consists of a water reservoir connected to an electric motor driven by the bikes electrical system to push water through tubing toward and out nozzles mounted on the motorcycle's handle bars.

### CROSS REFERENCE TO RELATED APPLICATIONS

This application claims priority from U.S. Provisional Patent Application Ser. No. 60/945,360, entitled “Personal Cooling Device for a Motorcycle Rider”, filed on 21 Jun. 2008.

### SEQUENCE LISTING OR PROGRAM

Not Applicable

### FEDERALLY SPONSORED RESEARCH

Not Applicable

### TECHNICAL FIELD OF THE INVENTION

The present invention relates generally to personal cooling devices. More specifically the present invention relates to a personal cooling device for use during the operation of a motorcycle.

### BACKGROUND OF THE INVENTION

Efforts have been made to provide personal cooling devices that can be worn by a motorcycle rider to provide a cooling effect during hot weather. However, prior art personal cooling devices suffer from a combination of the following drawbacks: (A) short duration of cooling effect; (B) lack of portability; (C) lack of ability to keep coolant in a targeted area; (D) high cost of manufacture; (E) lack of a means for convenient storage when not in use; (F) lack of means for advertising media; (G) lack of hygienically acceptable means of public re-use or recycling; (H) requires access to a cooling media that may not be stored practically or that is not ready available under some conditions (e.g. ice in remote locations).

What is called for is a method of cooling a rider and/or passenger on a motorcycle and keeping them hydrated during short or long trips in hot weather or in hot, dry climates.

### SUMMARY OF THE INVENTION

The present invention is a personal cooling device for use during the operation of a motorcycle to provide a mist of water to keep a rider or passenger cool during hot weather. The device in a first embodiment consists of a water reservoir connected to an electric motor driven by the bikes electrical system to push water through tubing toward and out nozzles mounted on the motorcycle's handle bars.

It is therefore an objective of the present invention to provide a means for safely and easily allowing a rider to regulate their body temperature while riding in hot weather conditions for an extended period of time.

It is another objective of the present invention to teach a personal cooling device that can be integrated into the existing electrical and mechanical systems of a motorcycle.

### BRIEF DESCRIPTION OF THE DRAWINGS

FIG. 1 is a plain view of the personal cooling device of the present invention.

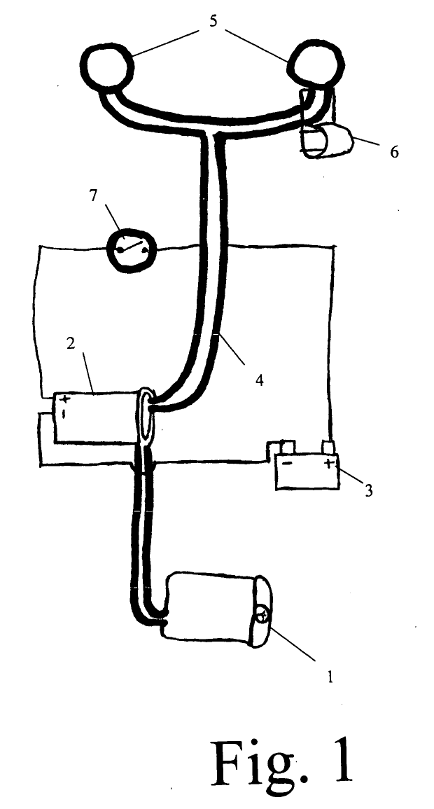

### DETAILED DESCRIPTION OF THE INVENTION

In the following detailed description of the invention of exemplary embodiments of the invention, reference is made to the accompanying drawings (where like numbers represent like elements), which form a part hereof, and in which is shown by way of illustration specific exemplary embodiments in which the invention may be practiced. These embodiments are described in sufficient detail to enable those skilled in the art to practice the invention, but other embodiments may be utilized and logical, mechanical, electrical, and other changes may be made without departing from the scope of the present invention. The following detailed description is therefore, not to be taken in a limiting sense, and the scope of the present invention is defined only by the appended claims.

In the following description, numerous specific details are set forth to provide a thorough understanding of the invention. However, it is understood that the invention may be practiced without these specific details. In other instances, well-known structures and techniques known to one of ordinary skill in the art have not been shown in detail in order not to obscure the invention.

The present invention is a personal cooling device for use during the operation of a motorcycle to provide a mist of water to keep a rider or passenger cool during hot weather. The device, in a first embodiment, consists of a water reservoir 1 connected to an electric motor 2 driven by the bikes electrical system 3 to push water through tubing 4 toward and out nozzles 5 mounted on the motorcycle's handle bars.

To use the device, a rider pushes a button 7, which activates the electric motor 2 that forces water from the reservoir 1 through the tubes 4 and out the nozzles 5. When the motor 2 is activated a mist of water is released from the nozzles 5 that is then forced by ejection and wind forces onto the rider's arms, chest, and head as directed by the nozzles 5 to provide cooling and maintain moisture on the rider's skin and clothing.

The reservoir 1 used by the present invention may be installed in multiple embodiments. The reservoir 1 generally consists of a plastic bottle either fixed or removably mounted to the motorcycle's frame, fenders or other fixed locations. In an alternative embodiment the reservoir 1 may be mounted in a backpack on the rear seat or rack of the motorcycle or front pack located of the front fenders. In these embodiments, the pack is typically mounted using Velcro to a backrest, handlebars, front forks, or a rack. Pack mounting allows for easy portability for refilling and other multi-functions of the reservoir 1, in an embodiment where the reservoir 1 can double as a drinking bottle.

The activation button 7 of the present invention can be a simple on/off switch, a hold on switch, or a timer switch that is activated by initial activation and remains on for a preset amount of time that may be adjustable to rider specific desires. Any button used is required to be installed and integrated into the motorcycle's electrical system 3. In an alternative embodiment, a user could install the system and use an existing motorcycle button to activate the device.

The nozzles 5 used by the device are adjustable via thumb wheel controls. By adjusting the thumb wheels a rider can change the amount and type of flow during system activation. The nozzles 5 are adjustable to change the volume of water flow and the type of spray from stream to fine mist. An alternative means for adjusting water flow is to replace the nozzles 5 with those of other sized apertures.

The tubing 4 used in the present invention to connect the electric motor 2 to the reservoir 1 and the electric motor 2 to the nozzles 5 is preferably constructed from ¼ clear tubing acceptable for drinking. In alternative embodiments of the device, various other sizes of tubing may be used as well. A less desirable alternative is the use of black rubber tubing, as this tubing has been found to result in a foul-tasting water being emitted from the nozzles 5 as a result of water remaining in the tubes during a period of inactivity.

The nozzles 5 may be connected and secure to the motorcycle in a variety of ways, each with its own advantages and disadvantages. In one embodiment, a clamp 6 can be used to secure the nozzles 5 to the motorcycle's handle bars, but this is a less desirable manner of attachment as many motorcycle owners are hesitant to use clamps on their bikes as they can damage paint or chrome finishes or results in scratch or scuff marks to the surface. In another embodiment, a bracket can be mounted to the handlebars and provide a securing means for the nozzles 5. When using a bracket, holes are provided which allow the tubing 4 to be inserted into one side of the bracket and secured on the other side of the bracket by the nozzles 5 attachment to the tubes 4.

A final securing means is the use of putty compound that can provide a securing means for the nozzles 5 to the handlebars, but is also easily removable by being peeled off, leaving no residue or damage to the handle bar surface to which is was applied.

In addition, other areas of art may benefit from this method and adjustments to the design are anticipated. Thus, the scope of the invention should be determined by the appended claims and their legal equivalents, rather than by the examples given.

The embodiments of the invention in which an exclusive property or privilege is claimed are defined as follows:

1. A personal cooling device for use during the operation of a motorcycle comprising in combination:
a motorcycle;
a water reservoir;
an electric motor;
an activation button;
tubing; and
one or more nozzles mounted on said motorcycle's handle bars.

2. The personal cooling device for use during the operation of a motorcycle of claim 1 wherein, said motorcycle's electrical system provides power for the electric motor to push water through tubing toward and out nozzles mounted on the motorcycle's handle bars.

3. The personal cooling device for use during the operation of a motorcycle of claim 1 wherein,
the activation button controls the electric motor, which forces water from the reservoir through the tubes and out the nozzles, and
a mist of water is released from the nozzles.

4. The personal cooling device for use during the operation of a motorcycle of claim 1 wherein,
the reservoir is comprised of a plastic bottle either fixed or removably mounted to the motorcycle's frame, fenders, or other fixed locations.

5. The personal cooling device for use during the operation of a motorcycle of claim 4 wherein, the reservoir is mounted in a pack on the rear seat or rack of the motorcycle or front pack located of the front fenders.

6. The personal cooling device for use during the operation of a motorcycle of claim 5 wherein, the pack is mounted using hook and loop fasteners to a backrest, handlebars, front forks, or the rack of the motorcycle.

7. The personal cooling device for use during the operation of a motorcycle of claim 5 wherein, the reservoir can double as a drinking bottle.

8. The personal cooling device for use during the operation of a motorcycle of claim 1 wherein,
the activation button is a simple on/off switch, a hold on switch, or a timer switch that is activated by initial activation and remains on for a preset amount of time that may be adjustable to rider specific desires, and
any button used is required to be powered by the motorcycle's electrical system.

9. The personal cooling device for use during the operation of a motorcycle of claim 1 wherein, an existing motorcycle button is used to activate the device.

10. The personal cooling device for use during the operation of a motorcycle of claim 1 wherein, the nozzles are adjustable via thumb wheel controls providing means to change the volume of water flow and the type of spray from stream to fine mist.

11. The personal cooling device for use during the operation of a motorcycle of claim 1 wherein, adjusting water flow is provide by replacing the nozzles with those of other sized apertures.

12. The personal cooling device for use during the operation of a motorcycle of claim 1 wherein, the tubing used to connect the electric motor to the reservoir and the electric motor to the nozzles is preferably constructed from clear tubing acceptable for drinking.

13. The personal cooling device for use during the operation of a motorcycle of claim 1 wherein, the tubing used to connect the electric motor to the reservoir and the electric motor to the nozzles is preferably constructed from ¼ clear tubing acceptable for drinking.

14. The personal cooling device for use during the operation of a motorcycle of claim 1 wherein,
the nozzles are connected and secured to the motorcycle by a clamp used to secure the nozzles to the motorcycle's handle bars.

15. The personal cooling device for use during the operation of a motorcycle of claim 1 further comprising,
a bracket mounted to the handlebars to provide a securing means for the nozzles;
holes are provided on the bracket that allow the tubing to be inserted into one side of the bracket and secured on the other side of the bracket by the nozzles attachment to the tubes.

16. The personal cooling device for use during the operation of a motorcycle of claim 1 further comprising, a putty compound that can provide a securing means for the nozzles to the handle bars.
